(19) United States
(12) Patent Application Publication
(10) Pub. No.: US 2014/0169699 A1
(43) Pub. Date: Jun. 19, 2014

(54) PANORAMIC IMAGE VIEWER

(71) Applicant: TAMAGGO INC., Montreal (CA)

(72) Inventor: Dongxu LI, Pointe-Claire (CA)

(73) Assignee: TAMAGGO INC., Montreal (CA)

(21) Appl. No.: 13/950,575

(22) Filed: Jul. 25, 2013

Related U.S. Application Data
(60) Provisional application No. 61/704,082, filed on Sep. 21, 2012.

(51) Int. Cl. G06T 19/00; G06T 3/00

(52) U.S. Cl. CPC G06T 19/00; G06T 3/00
USPC 382/285

(57) ABSTRACT

A viewer relying on a conformal projection process to perserve local shapes is provided employing a rotated cylindriac mapping. In the image generation process, the source panoramic image, which can be elliptical, is placed on a sphere according to the angular location of pixels in the panomorph. The sphere is rotated around its center to a desired orientation before being projected to a cylinder also centered at the sphere's center with its longitudinal axis along the sphere's z-axis. The projected image on the cylinder is unwrapped and displayed by the viewer.

### REFERENCE TO RELATED APPLICATIONS

This application is a non-provisional, and claims priority from, U.S. Provisional Patent Application U.S. 61/704,082 entitled “PANORAMIC IMAGE VIEWER” filed 21 Sep. 2013 the entirety of which is incorporated herein by reference.

### FIELD

The subject matter relates to image processing and in particular to a panoramic image viewer.

### BACKGROUND

A typical skybox based viewer introduces pincushion distortion when projecting the 3D skybox to a flat display, as shown in FIG. 1. The projection process is not conformal, as the longitudinal and latitudinal lines are not kept perpendicular to each other. Moreover, due to the perspective projection with the viewer located at the center, current environmental mapping schemes, such as cubic mapping and skydome mapping, can not support a field-of-view (FOV) greater than 90 degrees. Indeed, significant distortion happens whenever the FOV gets close to 90 degrees, and thus the aforementioned conventional environmental mapping methods are limited to about 45 degrees in practice. It would therefore be desirable to correct the pincushion distortion and limited FOV problems to avoid distorting the local shape of objects such as faces.

### SUMMARY

A viewer in accordance with a non-limiting embodiment of the present invention relies on a conformal projection process to perserve local shapes. For example, a rotated cylindriac mapping can be used. In the image generation process, the source panoramic image, which can be elliptical, is placed on a sphere according to the angular location of pixels in the panomorph. The sphere is rotated around its center to a desired orientation before being projected to a cylinder also centered at the sphere's center with its longitudinal axis along the sphere's z-axis. The projected image on the cylinder is unwrapped and displayed by the viewer. Because the new mapping algorithm is based on unwrapping a developable plane with projected panorama, FOV is not particularly limited.

### BRIEF DESCRIPTION OF THE DRAWINGS

The invention will be better understood by way of the following detailed description of embodiments of the invention with reference to the appended drawings, in which:

FIG. 1 is an illustration of a pincussion distortion;

FIG. 2 is a schematic diagram illustrating relationships between spaces;

FIG. 3(a) is a schematic diagram illustrating rendering a view of a texture surface on a screen in accordance with the proposed solution;

FIG. 3(b) is a schematic diagram illustrating a 2-D geometric mapping of a textured surface in accordance with the proposed solution;

FIG. 4 is schematic diagram illustrating a schetch of the geometry involved in accordance with the proposed solution;

FIG. 5 is a table illustrating image processing in accordance with the proposed solution;

FIG. 6 is an illustration having reduced pincussion distortion compared to the illustration in FIG. 1 in accordance with the proposed solution;

FIG. 7 is an algorithmic listing illustrating a rotated equirectagular mapping in accordance with a non-limiting example of the proposed solution;

FIG. 8 is an illustration of a mappping from an elliptic panorama image to a viewer window in accordance with the proposed solution;

FIG. 9 is an illustration of a 90 degree FOV mappipng from an elliptic panorama image in accordance with the proposed solution; and

FIG. 10 is another illustration of a 90 degree FOV mappipng from an elliptic panorama image in accordance with the proposed solution,

wherein similar features bear similar labels throughout the drawings.

### DETAILED DESCRIPTION

To discuss texture mapping, several coordinate systems can be defined. Texture space is the 2-D space of surface textures and object space is the 3-D coordinate system in which 3-D geometry such as polygons and patches are defined. Typically, a polygon is defined by listing the object space coordinates of each of its vertices. For the classic form of texture mapping, texture coordinates (u, v) are assigned to each vertex. World space is a global coordinate system that is related to each object's local object space using 3-D modeling transformations (translations, rotations, and scales). 3-D screen space is the 3-D coordinate system of the display, a perspective space with pixel coordinates (x, y) and depth z (used for z-buffering). It is related to world space by the camera parameters (position, orientation, and field of view). Finally, 2-D screen space is the 2-D subset of 3-D screen space without z. Use of the phrase “screen space” by itself can mean 2-D screen space.

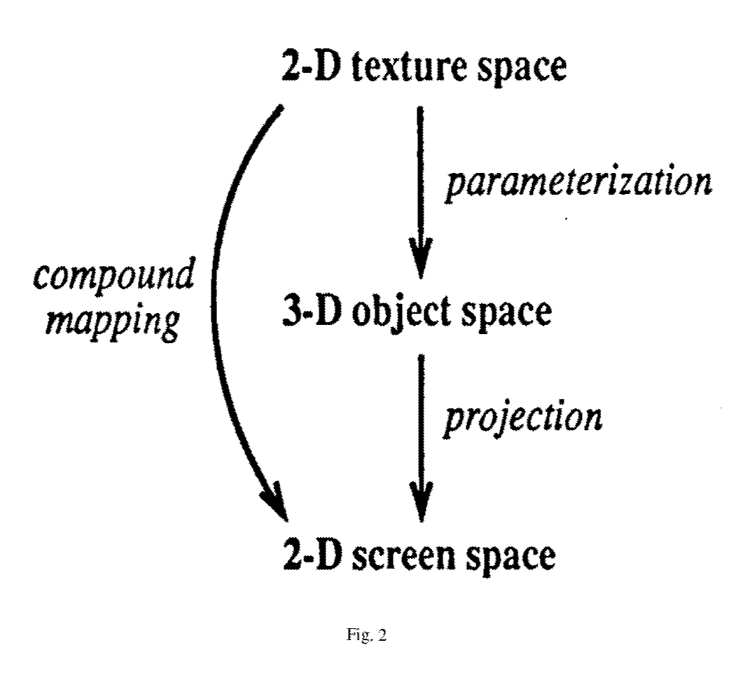

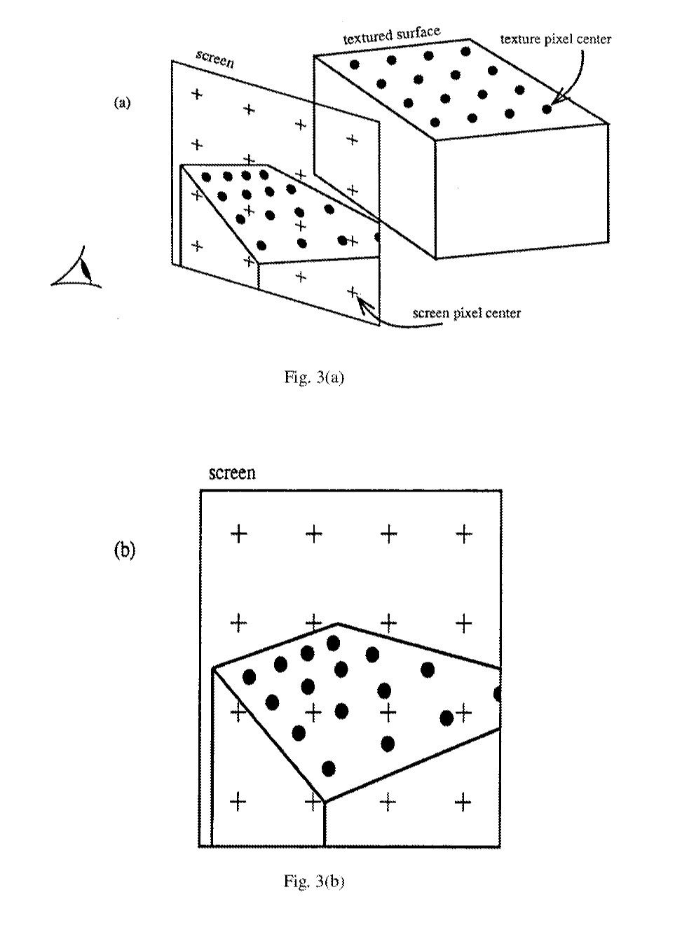

The correspondence between 2-D texture space and 3-D object space is called the parameterization of the surface, and the mapping from 3-D object space to 2-D screen space is the projection defined by the camera and the modeling transformations (FIG. 2). Note that when rendering a particular view of a textured surface (see FIG. 3(a)), it is the compound mapping from 2-D texture space to 2-D screen space that is of interest. For resampling purposes, once the 2-D to 2-D compound mapping is known, the intermediate 3-D space can be ignored. The compound mapping in texture mapping is an example of an image warp, the resampling of a source image to produce a destination image according to a 2-D geometric mapping (see FIG. 3(b)).

For an image to be generated by the viewer, a pixel in the display, indexed as (u; v), is mapped to a cylinder with unit radius in 3-dimensional space by equirectangular projection as shown by Eq. (1):

$$\{ \begin{matrix}{ϕ}_{c} = \frac{2 π}{w} ( u - \frac{w}{2} ) \\ {x}_{c} = cos {ϕ}_{c} \\ {y}_{c} = sin {ϕ}_{c} \\ {z}_{c} = \frac{2 π}{w} ( \frac{h}{2} - v )\end{matrix} \qquad ( 1 )$$

where φc and zc are the azimuth and height in cylindriac coordinates, respectively, and w and h are the width and height of the view image, respectively. Linear mapping is used to perserve angular uniformity in both directions along the u-indices and v-indices.

Next, the point on the cylinder (which was just found) is mapped to a unit sphere by normalization of its cartesian coordinates, and the point on the unit sphere is rotated. This can be expressed by:

$$( \begin{matrix}{x}_{c} \\ {y}_{c} \\ {z}_{c}\end{matrix} ) = {r}_{c} F \cdot ( \begin{matrix}{x}_{s} \\ {y}_{s} \\ {z}_{s}\end{matrix} ) \qquad ( 2 )$$

where xc, yc, zc are respectively the cartesian coordinates of the point on the cylinder, rc is its distance to the origin, F is a rotation matrix, and (xs, ys, zs) are the cartesian coordinates of the point on the unit sphere. It is noted that the rotation matrix F is a function of user input. In other words, navigation throughout the original image will induce changes in F.

The color of the viewer pixel (which, will be recalled, is at (u; v) in the view window) is the color of a corresponding location within a 2D panoramic image, which can be elliptical (including but not limited to circular). This corresponding location can be obtained by first converting the cartesian coordinates of the aforementioned point on the unit sphere (xs; ys; zs) to spherical coordinates (1; Θs; φs) then recognizing the existence of a mapping between (general) spherical coordinates (1; Θ; φ) on the unit sphere and (general) polar coordinates (r_{E}, Θ_{E}) on an elliptic (circular or non-circular) panoramic image. In particular, this mapping can be defined as:

$$\{ \begin{matrix}{r}_{E} = f ( θ ) \\ {θ}_{E} = ϕ\end{matrix}$$

where f(Θ) is a mapping function defined by the camera lens projection, and may indeed be supplied by the camera in a form of an one-dimensional lookup table.

As a result, the texture coordinates in the original 2-D elliptic image that correspond to the point (u; v) in the viewing window are given by:

$$\{ \begin{matrix}s = \frac{1}{2} + f ( {θ}_{s} ) cos {ϕ}_{s} \\ t = \frac{1}{2} + f ( {θ}_{s} ) sin {ϕ}_{s} .\end{matrix} \qquad ( 3 )$$

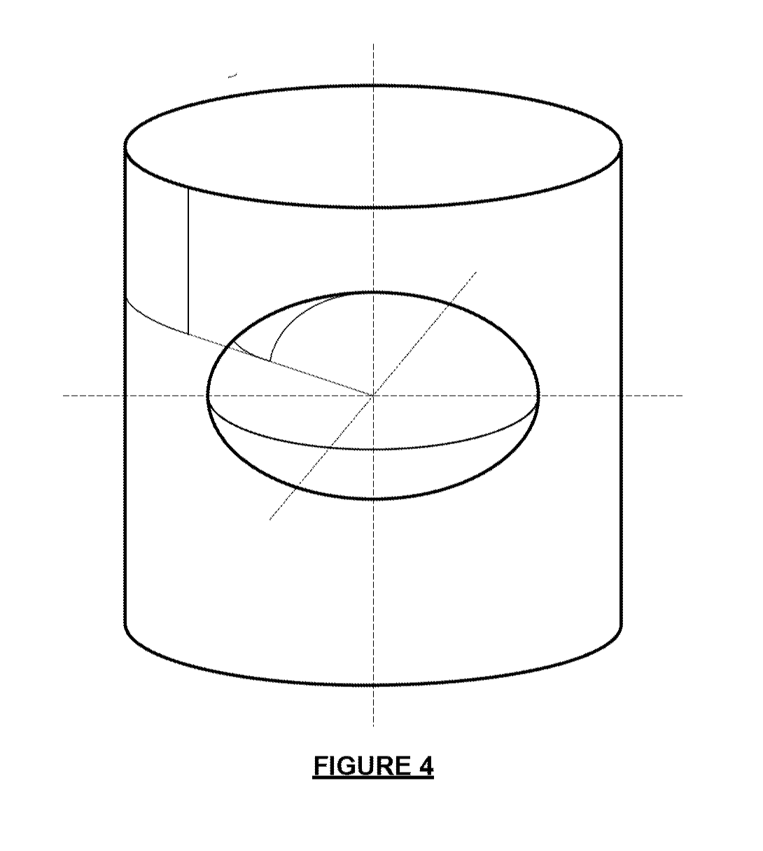

FIG. 4 shows a sketch of the geometry involved in the afoementioned process.

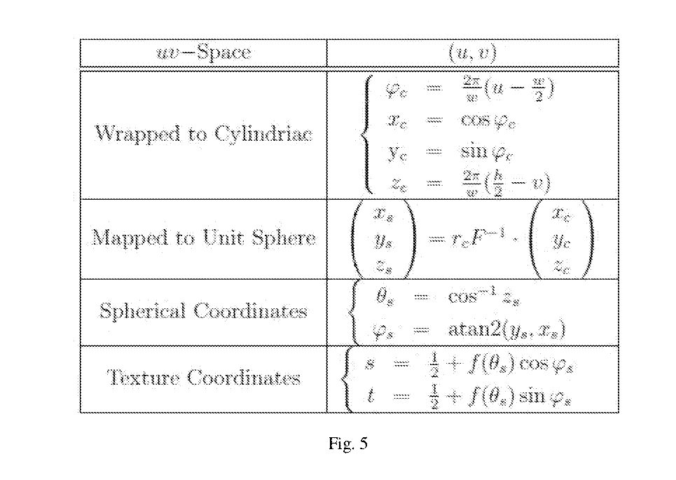

FIG. 5 shows a summary of the entire mapping process.

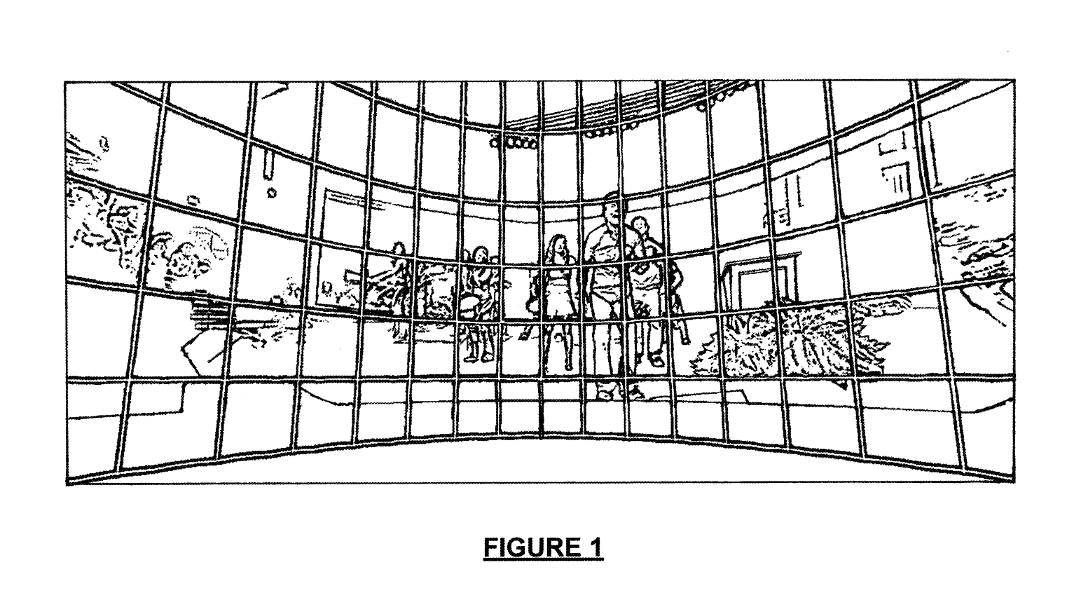

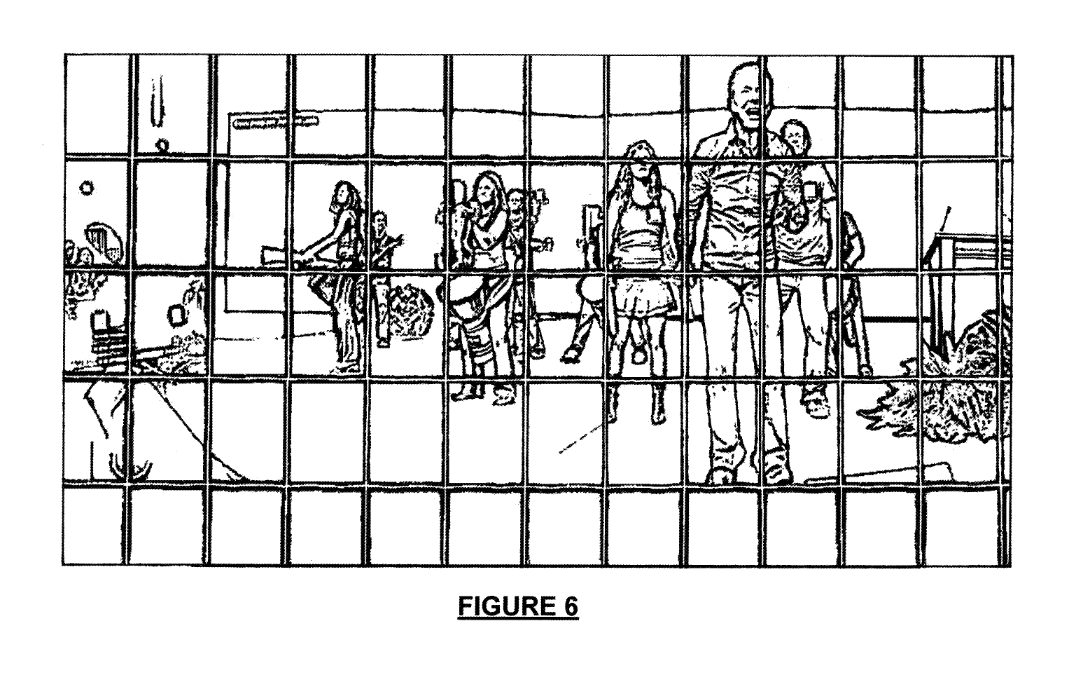

FIG. 6 shows a screenshot from a viewer implemented in accordance with an embodiment of the present invention. It is noted that the pincushion distortion from FIG. 1 has been reduced.

Implementation

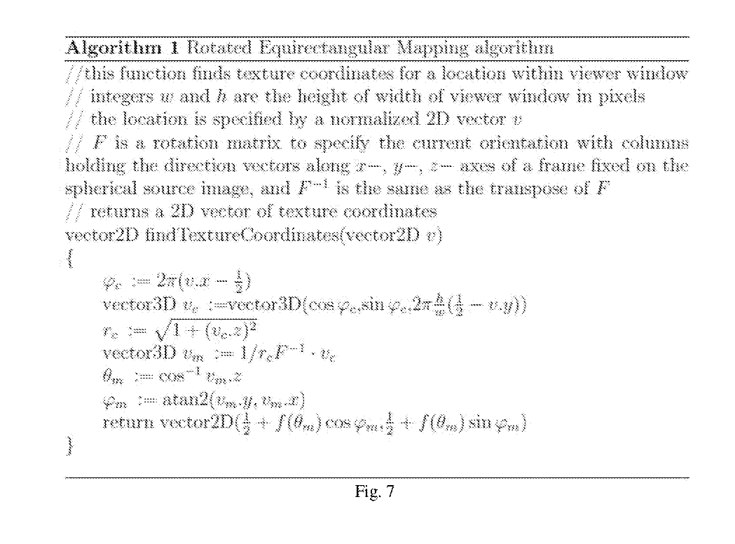

Algorithm 1 (see FIG. 7) finds the texture coordinates for a location within the viewer window. φc and zc are cylindriac coordinates from Eqn. (1), and

$$vc = ( \begin{matrix}{x}_{c} \\ {y}_{c} \\ {z}_{c}\end{matrix} )$$

is a column vector of the corresponding cartesian coordinates; rc is the length of the 2D vector vc; F is a rotation matrix which has columns holds the direction vectors along x-, y-, z- axes of a frame fixed on the spherical source image;

$$vs = ( \begin{matrix}{x}_{s} \\ {y}_{s} \\ {z}_{s}\end{matrix} )$$

is a column vector of the cartesian coordinates of the mapped point on the unit sphere.

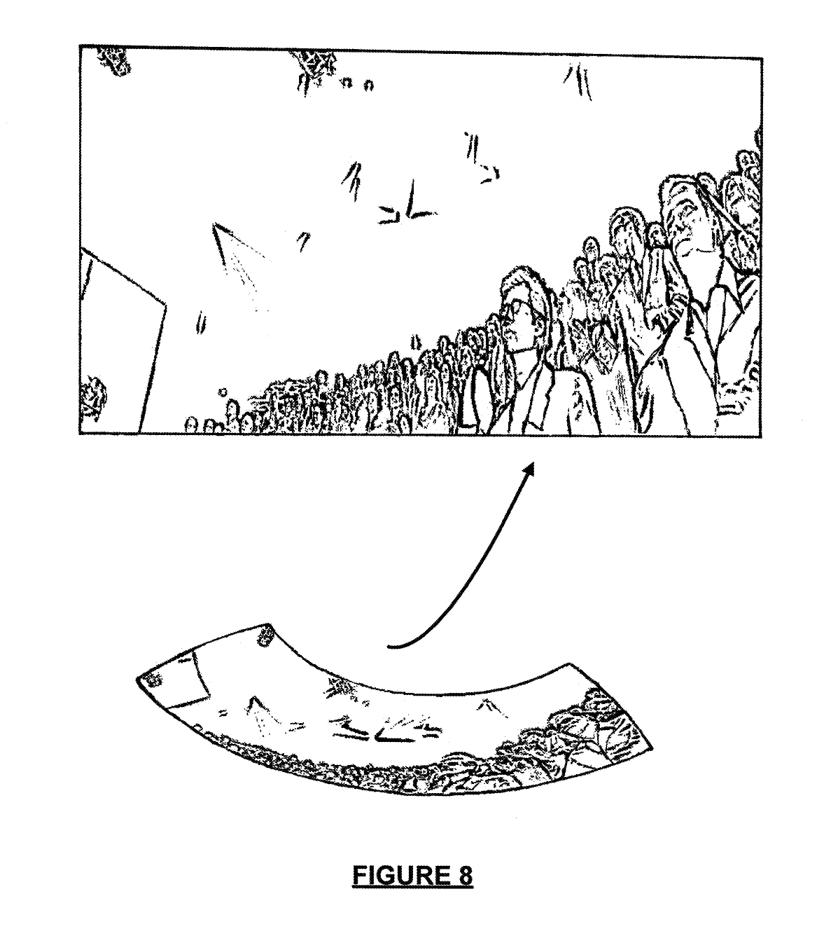

One example of mapping from an elliptic panorama image to the viewer window is shown in FIG. 8.

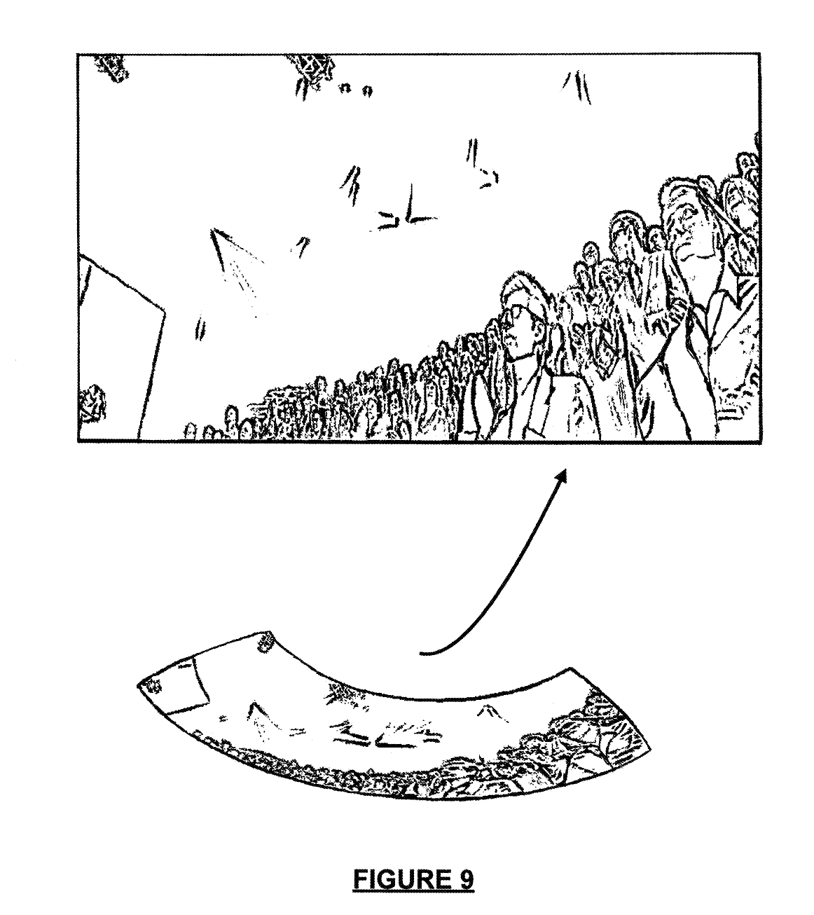

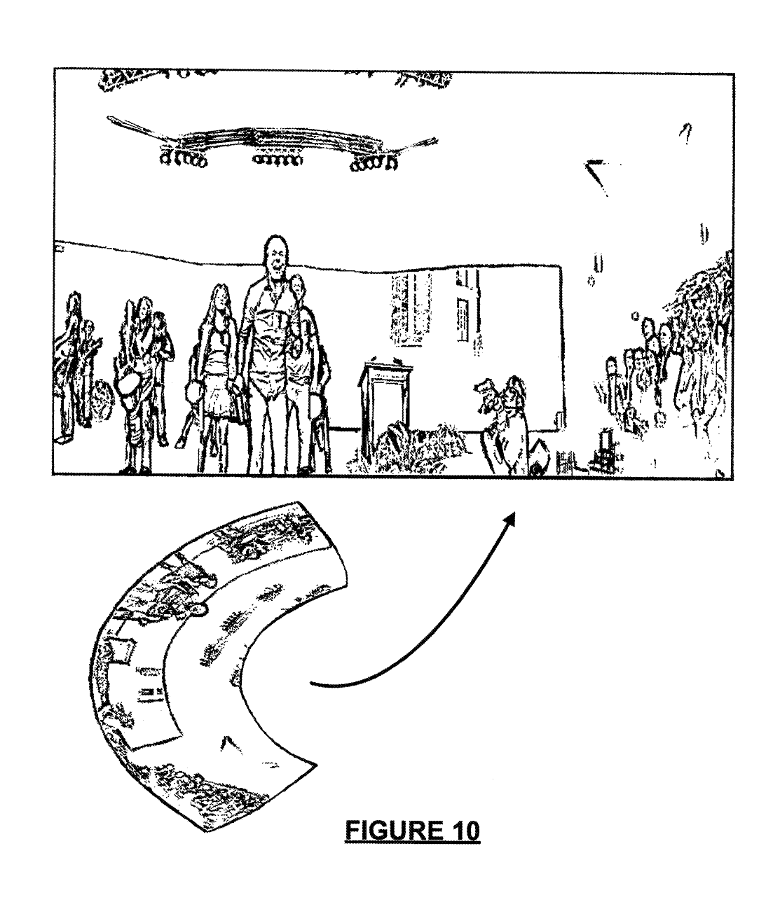

FIGS. 9 and 10 show how a portion of the elliptic panorama image is mapped to a viewer window at a 90 degree FOV.

Those skilled in the art will appreciate that a computing device may implement the methods and processes of certain embodiments of the present invention by executing instructions read from a storage medium. In some embodiments, the storage medium may be implemented as a ROM, a CD, Hard Disk, USB, etc. connected directly to (or integrated with) the computing device. In other embodiments, the storage medium may be located elsewhere and accessed by the computing device via a data network such as the Internet. Where the computing device accesses the Internet, the physical interconnectivity of the computing device in order to gain access to the Internet is not material, and can be achieved via a variety of mechanisms, such as wireline, wireless (cellular, Wi-Fi, Bluetooth, WiMax), fiber optic, free-space optical, infrared, etc. The computing device itself can take on just about any form, including a desktop computer, a laptop, a tablet, a smartphone (e.g., Blackberry, iPhone, etc.), a TV set, etc.

Moreover, persons skilled in the art will appreciate that in some cases, the panoramic image being processed may be an original panoramic image, while in other cases it may be an image derived from an original panoramic image, such as a thumbnail or preview image.

Certain adaptations and modifications of the described embodiments can be made. Therefore, the above discussed embodiments are to be considered illustrative and not restrictive. Also it should be appreciated that additional elements that may be needed for operation of certain embodiments of the present invention have not been described or illustrated as they are assumed to be within the purview of the person of ordinary skill in the art. Moreover, certain embodiments of the present invention may be free of, may lack and/or may function without any element that is not specifically disclosed herein.

What is claimed is:

1. A method of displaying a 2-D panoramic image in a viewing window, comprising;
obtaining 2-D coordinates of an element of the viewing window;
transforming the 2-D coordinates into a 3-D vector;
rotating the vector;
mapping the 3-D coordinates to 2-D coordinates of a panoramic image; and
obtaining color information of the panoramic image at the 2-D coordinates.

2. The method defined in claim 1, wherein the transforming comprises applying a projection of the 2-D coordinates onto a virtual 3-D shape.

3. The method defined in claim 2, wherein the virtual 3-D shape includes a cylinder.

4. The method defined in claim 1, further comprising normalizing the 3-D vector between the transforming and mapping steps.

5. The method defined in claim 4, wherein normalizing the vector comprises projectng the vector to the surface of the unit sphere.

6. The method defined in claim 1, further comprising obtaining a desired orientation of the viewing window and rotating the vector in accordance with the desired orientation.

7. The method defined in claim 1, wherein the panoramic image is elliptical.

8. The method defined in claim 7, wherein the panoramic image is captured by a camera.

9. The method defined in claim 1, wherein the panoramic image is circular.

10. The method defined in claim 1, wherein the steps are repeated for multiple elements in the viewing window.

11. A non-transitory computer-readable medium comprising instructions which, when executed by a computing apparatus, cause the computing apparatus to carry out a method that comprises:
obtaining 2-D coordinates of an element of the viewing window;
transforming the 2-D coordinates into a 3-D vector;
rotating the vector;
mapping the 3-D coordinates to 2-D coordinates of a panoramic image; and
obtaining color information of the panoramic image at the 2-D coordinates.
